(19) United States
(12) Patent Application Publication
(10) Pub. No.: US 2025/0162607 A1
(43) Pub. Date: May 22, 2025

(54) DRIVING ASSISTANCE APPARATUS, DRIVING ASSISTANCE METHOD, AND STORAGE MEDIUM

(71) Applicant: HONDA MOTOR CO., LTD., Tokyo (JP)

(72) Inventors: Kenjiro TORII, Wako-shi (JP); Kohei MATSUDA, Wako-shi (JP); Kiri YOSHIDA, Wako-shi (JP); Youngjun AN, Tokyo (JP)

(21) Appl. No.: 18/938,625

(22) Filed: Nov. 6, 2024

(30) Foreign Application Priority Data
Nov. 17, 2023 (JP) 2023-196123

(51) Int. Cl. B60W 50/14; G01C 21/30

(52) U.S. Cl. CPC B60W 50/14; G01C 21/30; B60W 2520/10; B60W 2552/20

(57) ABSTRACT

There is provided with a driving assistance apparatus. A first acquisition unit acquires map information. A second acquisition unit acquires shape information of a road within a predetermined range with respect to a mobile unit on a basis of the map information. An identification unit identifies a junction on the road within the predetermined range on the basis of the shape information. A first control unit controls notification regarding to merging at the identified junction, for the mobile unit in a case where a junction is identified in the road within the predetermined range.

### CROSS-REFERENCE TO RELATED APPLICATION(S)

This application claims priority to and the benefit of Japanese Patent Application No. 2023-196123 filed on Nov. 17, 2023, the entire disclosure of which is incorporated herein by reference.

### BACKGROUND OF THE INVENTION

### Field of the Invention

The present invention relates to a driving assistance apparatus, a driving assistance method, and a storage medium.

### Description of the Related Art

There is a technology for assisting vehicles in changing lanes. For example, Japanese Patent Laid-Open No. 2010-198468 discloses a technology for estimating the length of a merging section on the basis of the distance between two points recognized in the merging section imaged by a vehicle-mounted camera.

### SUMMARY OF THE INVENTION

According to one embodiment of the present disclosure, a driving assistance apparatus comprises: a first acquisition unit configured to acquire map information; a second acquisition unit configured to acquire shape information of a road within a predetermined range with respect to a mobile unit on a basis of the map information; an identification unit configured to identify a junction on the road within the predetermined range on the basis of the shape information; and a first control unit configured to control notification regarding to merging at the identified junction, for the mobile unit in a case where a junction is identified in the road within the predetermined range.

According to another embodiment of the present disclosure, a driving assistance method comprises: acquiring map information; acquiring shape information of a road within a predetermined range with respect to a mobile unit on a basis of the map information; identifying a junction on the road within the predetermined range on the basis of the shape information; and controlling notification regarding to merging at the identified junction, for the mobile unit in a case where a junction is identified in the road within the predetermined range.

According to yet another embodiment of the present disclosure, a non-transitory computer-readable storage medium stores a program that, when executed by a computer, causes the computer to perform a driving assistance method comprising: acquiring map information; acquiring shape information of a road within a predetermined range with respect to a mobile unit on a basis of the map information; identifying a junction on the road within the predetermined range on the basis of the shape information; and controlling notification regarding to merging at the identified junction, for the mobile unit in a case where a junction is identified in the road within the predetermined range.

### BRIEF DESCRIPTION OF THE DRAWINGS

FIG. 1 is a block diagram illustrating an example of the configuration of a vehicle M including a driving assistance apparatus;

FIG. 2 illustrates the determination of a merging assistance section;

FIG. 3 illustrates an example of notification regarding merging at a junction;

FIG. 4 illustrates an example of merging assistance in an acceleration section;

FIG. 5 illustrates another example of merging assistance in the acceleration section;

FIG. 6 illustrates still another example of merging assistance in the acceleration section;

FIG. 7 illustrates yet another example of merging assistance in the acceleration section;

FIG. 8 is a flowchart illustrating an example of control processing for notification regarding merging by the driving assistance apparatus; and

FIG. 9 is a flowchart illustrating an example of merging assistance processing by the driving assistance apparatus.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In the technology disclosed in Japanese Patent Laid-Open No. 2010-198468, positional data of highway junctions and exits is contained in map data. Therefore, there is a problem that, in order to execute each process including the estimation of the length of the merging section, the merging section needs to be indicated as a junction in the map data.

Therefore, an embodiment of the present invention provides a driving assistance apparatus that determines whether or not a place is a junction on the basis of road shape information

The driving assistance apparatus according to an embodiment of the present invention acquires map information and, on the basis of the acquired map information, acquires shape information of a road, which falls within a predetermined range from a mobile unit. Next, on the basis of the acquired shape information, a junction on the road within the predetermined range is identified, and if the junction is identified, notification regarding merging at the junction in the mobile unit is controlled.

The driving assistance apparatus according to the present embodiment is a vehicle-mounted device (ECU) mounted in a vehicle that is a mobile unit, and can control the vehicle according to each processing result, but may be a mobile terminal, a server, or the like as long as similar operation is possible, and is not limited thereto. The mobile unit according to the present embodiment refers to a structure that is autonomously movable by its own drive mechanism, such as a vehicle (four-wheeled or two-wheeled vehicle), a micro mobility vehicle, or an autonomous walking robot. Furthermore, in the following description, the mobile unit is assumed to be a vehicle moving on the ground.

### [System]

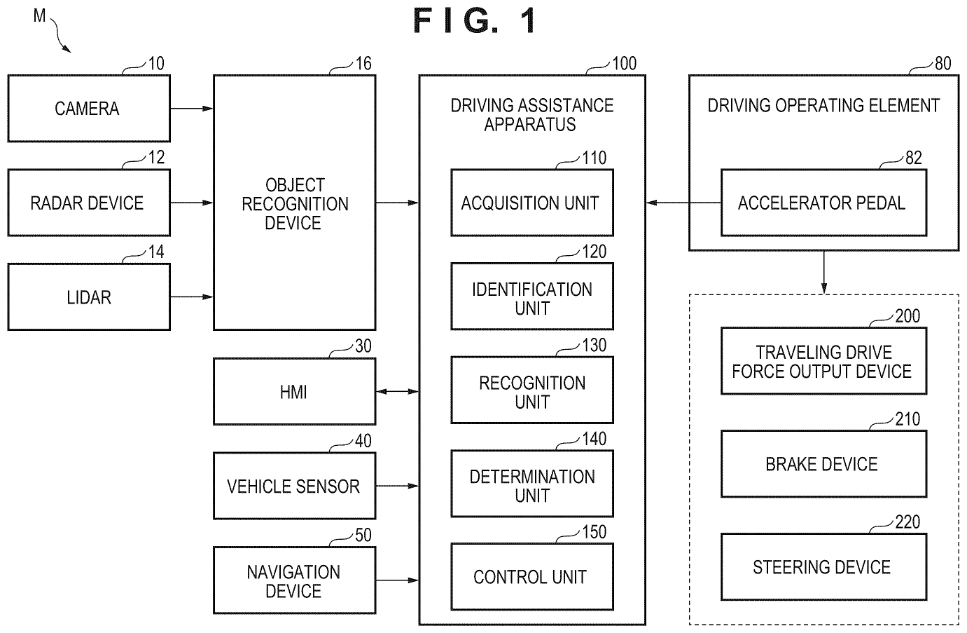

FIG. 1 is a block diagram illustrating an example of the hardware configuration of a vehicle M in which a driving assistance apparatus 100 according to the present embodiment is mounted. In FIG. 1, the vehicle M includes a camera 10, a radar device 12, a LiDAR 14, an object recognition device 16, a human machine interface (HMI) 30, a vehicle sensor 40, a driving operating element 80, a driving assistance apparatus 100, a traveling drive force output device 200, a brake device 210, and a steering device 220. The components of the vehicle M are connected to each other by a multiplex communication line such as a controller area network (CAN) communication line, a serial communication line, a radio communication network, or the like so as to be capable of sending and receiving information to and from each other. The configuration illustrated in FIG. 1 is an example, and part of the configuration may be omitted, or another configuration may be added.

The camera 10 is, for example, a digital camera using a solid-state imaging device such as a charge-coupled device (CCD) or a complementary metal oxide semiconductor (CMOS). The camera 10 is attached to any part of the vehicle M. When capturing an image of an area in front of the vehicle M, the camera 10 is attached to the top of a front window shield, the back of a room mirror, or the like. The camera 10 periodically and repeatedly captures images of an area around the vehicle M, for example. The camera 10 may be a stereo camera.

The radar device 12 emits radio waves such as millimeter waves to an area around the vehicle M, and detects the radio waves (reflected waves) reflected by an object to detect at least the position (distance and azimuth) of the object. The radar device 12 is attached to any part of the vehicle M. The radar device 12 may detect the position and speed of the object by a frequency modulated continuous wave (FM-CW) method.

The LiDAR 14 irradiates an area around the vehicle M with light (or electromagnetic waves having wavelengths close to light) and measures the scattered light. The LiDAR 14 detects the distance to a target on the basis of the time between light emission and light reception. The irradiated light is, for example, pulsed laser light. The LiDAR 14 is attached to any part of the vehicle M.

The object recognition device 16 performs sensor fusion processing on the detection results by some or all of the camera 10, the radar device 12, and the LiDAR 14 to recognize the position, type, speed, or the like of the object. The object recognition device 16 outputs the recognition results to the driving assistance apparatus 100. The object recognition device 16 may output the detection results of the camera 10, the radar device 12, and the LiDAR 14 to the driving assistance apparatus 100 as they are. In addition, the object recognition device 16 may be omitted.

The HMI 30 presents various types of information to an occupant of the vehicle M and receives input operations by the occupant. The HMI 30 includes various display devices, speakers, buzzers, vibration generators (vibrators), touch panels, switches, keys, or the like. The HMI 30 is an example of a “notification device”. As described above, in the present embodiment, since the driving assistance apparatus 100 is a vehicle-mounted device, the HMI 30 is a vehicle-mounted display device or the like. For example, if the driving assistance apparatus 100 is a mobile terminal (not illustrated) such as a smartphone carried by the user, the HMI 30 may be the display, speaker, or the like of such mobile terminal. In addition to the vehicle-mounted display device and speaker, notification such as vibration by the mobile terminal may also be made at the same time.

The vehicle sensor 40 includes a vehicle speed sensor for detecting the speed of the vehicle M, an acceleration sensor for detecting acceleration, a yaw rate sensor for detecting angular velocity around a vertical axis, an azimuth sensor for detecting the orientation of the vehicle M, and the like.

A navigation device 50 has, for example, a global navigation satellite system (GNSS) receiver, a guidance controller, a storage unit storing map information, and the like. The GNSS receiver identifies the position of the vehicle M on the basis of signals received from GNSS satellites. The position of the vehicle M may be identified or complemented by an inertial navigation system (INS) utilizing the output of the vehicle sensor 40. For example, the guidance controller determines a route from the position of the vehicle M identified by the GNSS receiver (or any input position) to a destination input by the occupant by referring to the map information, and causes the HMI 30 to output guidance information so that the vehicle M travels along the route. The map information is, for example, information in which road shapes are represented by links indicating roads and nodes connected by the links. The map information may include curvatures of roads, information of point of interest (POI), or the like. The navigation device 50 may transmit the current position and the destination of the vehicle M to a navigation server via a communication device and acquire a route from the navigation server.

The driving operating element 80 includes, for example, an accelerator pedal 82, a brake pedal, a steering wheel, a shift lever, and other operating elements. The accelerator pedal 82 is an example of an acceleration operating element. A sensor for detecting the amount of operation or the presence or absence of an operation is attached to the driving operating element 80, and the detection results thereof are output to some or all of the traveling drive force output device 200, the brake device 210, and the steering device 220.

The traveling drive force output device 200 outputs traveling drive force (torque) for the vehicle to travel to drive wheels. The traveling drive force output device 200 includes, for example, a combination of an internal combustion engine, an electric motor, a transmission, and the like, and an electronic control unit (ECU) that controls these. The ECU controls the above configuration in accordance with information input from the driving assistance apparatus 100 or information input from the driving operating element 80.

The brake device 210 includes, for example, a brake caliper, a cylinder that transmits hydraulic pressure to the brake caliper, an electric motor that causes the cylinder to generate hydraulic pressure, and an ECU. The ECU controls the electric motor in accordance with to the information input from the driving assistance apparatus 100 or from the driving operating element 80 so that the brake torque corresponding to a braking operation is output to each wheel. The brake device 210 may include a mechanism, as a backup, in which the hydraulic pressure generated by an operation of the brake pedal included in the driving operating element 80 is transmitted to the cylinder via a master cylinder. Note that the brake device 210 is not limited to the above-described configuration and may be an electronically-controlled hydraulic brake device in which an actuator is controlled in accordance with the information input from the driving assistance apparatus 100 and the hydraulic pressure of the master cylinder is transmitted to the cylinder.

The steering device 220 includes, for example, a steering ECU and an electric motor. The electric motor, for example, exerts a force on a rack-and-pinion mechanism to change the orientation of steered wheels. The steering ECU drives the electric motor to change the orientation of the steered wheels in accordance with the information input from the driving assistance apparatus 100 or from the driving operating element 80.

### [Driving Assistance Apparatus]

The driving assistance apparatus 100 acquires map information and, on the basis of the map information, acquires shape information of a road within a predetermined range. Next, the driving assistance apparatus 100 identifies a junction on the road within the predetermined range on the basis of the acquired shape information. Furthermore, if the junction is identified on the road within the predetermined range, the driving assistance apparatus 100 controls notification regarding merging at the junction, for the vehicle M. Hereinafter, the configuration of the driving assistance apparatus 100 and processing executed by the driving assistance apparatus 100 will be described with reference to FIGS. 1 to 9.

A recognition unit 130 among the components included in the driving assistance apparatus 100 may be in operation at all times, regardless of the scene in which the vehicle M is placed. The scene in which the vehicle M changes lanes from a merging lane into a merged lane can be recognized, for example, by the recognition unit 130 checking the position of the vehicle M measured by the navigation device 50 against the map information.

The driving assistance apparatus 100 according to the present embodiment includes an acquisition unit 110, an identification unit 120, the recognition unit 130, a determination unit 140, and a control unit 150. These functional units are implemented by, for example, a hardware processor such as a central processing unit (CPU) executing a program (software). In addition, some or all of these components may be implemented by hardware (a circuit; including circuitry) such as a large-scale integration (LSI), an application specific integrated circuit (ASIC), a field-programmable gate array (FPGA), or a graphics processing unit (GPU), or may be implemented by software and hardware in cooperation. A program may be stored in advance in a storage device (a storage device including a non-transitory storage medium) such as the HDD or flash memory of the driving assistance apparatus 100, or may be stored in a detachable storage medium, such as a DVD or a CD-ROM, and installed in the HDD or flash memory of the driving assistance apparatus 100 when the storage medium (non-transitory storage medium) is attached to a drive device.

The acquisition unit 110 acquires map information. The acquisition unit 110 may acquire the map information from the navigation device 50, or the navigation device 50 may be included in the driving assistance apparatus 100. The map information according to the present embodiment may be acquired on the basis of the position of the vehicle M, on the basis of user input, or on the basis of preset information.

In addition, the acquisition unit 110 acquires shape information of a road within a reference range on the basis of the acquired map information. In the subsequent processing, junctions are identified, with the road within the predetermined range as an object to be processed. Hereinafter, such predetermined range is referred to as the “reference range”. The shape information according to the present embodiment indicates the shape of a road and may be, for example, information in which the shape of a road is represented by links indicating the road and nodes connected by the links, contained in the map information described above. The road shape can be acquired by any method as long as such referable road shape is acquired.

The acquisition unit 110 can set the reference range described above. Hereinafter, the setting of the reference range by the acquisition unit 110 will be described. The acquisition unit 110 may set the reference range on the basis of the position of the vehicle M. For example, the acquisition unit 110 may set, as the reference range, a rectangular range of a predetermined size (for example, 5 km by 5 km) with the vehicle M as the center in the map information. Hereinafter, the reference range is assumed to be a single rectangular range, but may be, for example, a circular range, or there may be a plurality of ranges. Furthermore, in a case where the reference range is set with respect to the position of the vehicle M, the position of the vehicle M does not need to be the center of the reference range, and for example, the reference range may be set so as to include, for example, a wider range in the travel direction of the vehicle M. In this case, as the vehicle M moves, the position of the reference range also changes, and the subsequent processing is based on the road shape within such dynamically-changing reference range.

In addition, the size of the reference range may be fixed or may vary depending on the state of the vehicle M. For example, the size of the reference range may be determined on the basis of the speed of the vehicle M. In this case, the acquisition unit 110 can set the reference range so that the larger the speed of the vehicle M, the larger the reference range (for example, the length of one side of the reference range, which is a square range, is set to 5 km when the vehicle speed is 40 km/h, and 6 km when the vehicle speed is 60 km/h). In addition, the acquisition unit 110 may set the reference range so as to include the position of the vehicle M and a candidate for a junction to be described later.

In addition, the acquisition unit 110 can set a candidate for a junction in the map information and set the reference range so as to include the candidate within the range. For example, the acquisition unit 110 can set the position of a node contained in the map information as a candidate for a junction. In addition, for example, the acquisition unit 110 can set, as a candidate for a junction, a node that satisfies a predetermined condition among the nodes contained in the map information. Here, a node satisfying one or more specific conditions to be described later among the nodes may be set as a candidate for a junction. Note that, when setting a candidate for a junction in this manner, the range to be searched for setting such candidate is not limited as long as the range is equal to or larger than the reference range. For example, the acquisition unit 110 may set a candidate for a junction from the entire map information acquired as an object to be processed. Furthermore, for example, if the reference range is a rectangular region, the size of which varies within a predetermined range depending on the speed of the vehicle M or the like, the acquisition unit 110 may set a candidate for a junction from the maximum size range (for example, from a range of 10 km×10 km with the vehicle M as the center if the reference range is a square region, the size of which varies from 3 km×3 km to 10 km×10 km).

In addition, if the density of roads or intersections is high and the roads are congested, it is conceivable that the probability of incorrectly estimating that a road is a junction increases. From such a viewpoint, the acquisition unit 110 can identify the number of roads and the number of intersections within the reference range and change the size of the reference range on the basis of the number of roads and the number of intersections. For example, the acquisition unit 110 may decrease the size of the reference range if the sum of the number of roads and the number of intersections exceeds a predetermined threshold value (for example, 100), or if a weighted sum, such as the sum of twice the number of roads, and the number of intersections, exceeds a predetermined threshold value. In this case, for example, if the total value described above exceeds the predetermined threshold value, the size of the reference range may be changed to a predetermined size (for example, from 5 km×5 km to 3 km×3 km) smaller than the current size, but the reference range may also be set such that the reference range becomes smaller as the total value becomes larger. Note that the “intersection” in the present embodiment is a point where roads cross, and includes both a junction and a point that is not a junction.

In the present embodiment, links contained in map information are identified as roads, and nodes are identified as intersections. However, the intersections and roads on the map can be identified using any known technology that uses maps, and the method is not limited thereto.

The identification unit 120 identifies a junction on the road within the reference range on the basis of the shape information. The identification unit 120 according to the present embodiment identifies, as a merging lane, the place satisfying a predetermined condition within the reference range. Hereinafter, such predetermined condition will be referred to as a “specific condition”, and such specific condition will be described.

If two roads join into one, the number of lanes after the joining is reduced. From such a viewpoint, the identification unit 120 may identify, for example, a place where two roads join (where the number of roads decreases around that point) as a junction. In addition, for example, it is conceivable that, at a junction, the number of lanes on the road joining a main lane is two or less. Therefore, the identification unit 120 may identify a place where two roads join as a junction if the number of lanes on one of the roads before joining is two or less. Furthermore, if the identification unit 120 identifies a junction that is not an intersection, it is conceivable that the angle at which two roads join is small to some extent. From such a viewpoint, if the angle at which two roads join is equal to or less than a predetermined threshold value (for example, 60 degrees), the identification unit 120 may identify the joining place as a junction. As the angle at which two roads join, the angle between the links with respect to the node is used, but a value calculated by a different method may be used as long as the joint angle between two roads can be evaluated similarly.

In addition, if the roads joining together have a specific attribute added thereto in the map information, the identification unit 120 may also identify the place where the roads join together as a junction. For example, if the road after joining has an attribute indicating that the road is an expressway or an arterial road, the identification unit 120 may identify the joining place as a junction. Alternatively, for example, if at least one of the roads before joining has an attribute indicating that the road is a highway entrance or exit, the identification unit 120 may identify the joining place as a junction. Alternatively, for example, if, as an additional specific condition, neither carpool use attributes nor express use attributes are added to any of the roads before joining, the identification unit 120 may identify the joining place as a junction.

In the present embodiment, a place that satisfies any of the specific conditions described above is identified as a junction, but a place may also be identified as a junction if the place satisfies a plurality (for example, two or more) of such specific conditions. The place may also be identified as a junction if a combination of some of such specific conditions is satisfied. The configuration that identifies the place as a junction if a plurality of specific conditions are satisfied allows an improvement in the accuracy of estimating whether or not the place is a junction. In addition, the specific conditions mentioned here are merely examples, and other specific conditions may be set as long as the specific conditions are conditions for determining a junction.

If a junction is identified on the road within the reference range, the control unit 150 controls notification regarding merging at the identified junction, for the vehicle M. The control unit 150 according to the present embodiment can control, for example, the notification of confirmation as to whether or not to execute merging assistance processing to be described later in the identified junction, or the notification indicating that the merging assistance processing is to be executed. In the following description, it is assumed that a notification is made to confirm whether or not to execute merging assistance processing is made as a notification regarding merging.

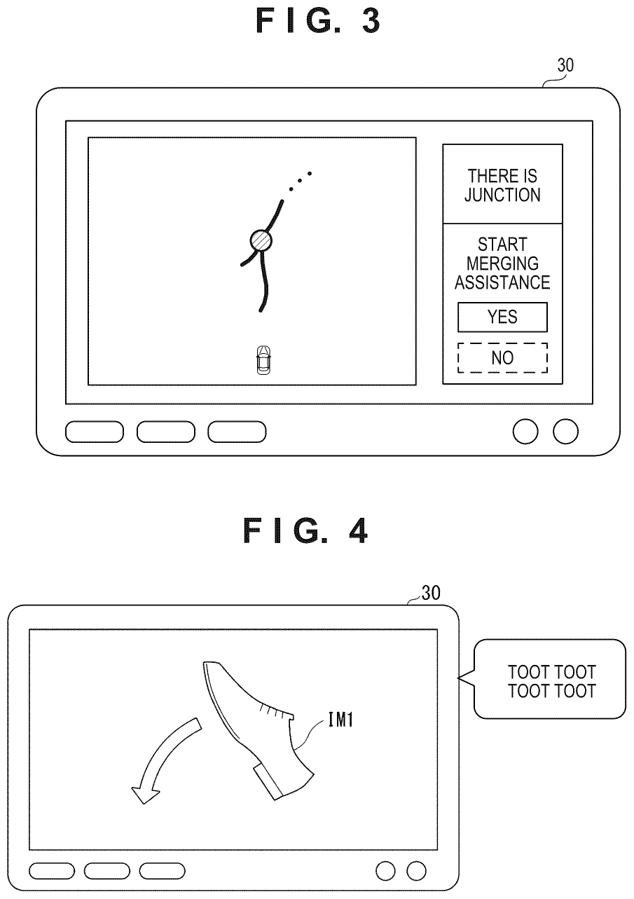

An example of such notification is illustrated in FIG. 3. FIG. 3 illustrates an example of notification regarding merging at a junction as displayed on the HMI 30 of the vehicle M. In FIG. 3, an indication that there is a junction near the vehicle M and an indication for selecting whether or not to provide merging assistance at the junction are displayed on the screen of the display device. Here, the HMI 30 accepts user input and, if the input requesting merging assistance is made, executes processing for merging assistance at the junction. If input requesting no merging assistance is made, it is recorded that merging assistance is not to be performed at the junction, and subsequently, identification of a junction within the reference range is executed. Note that, here, the description will be given assuming that the user performs input via a mechanical switch or a touch panel, but for example, input by voice recognition may be possible, and any other method of acquiring input by the user may be used.

Here, in addition to the display of notifications, notifications by voice are also provided. The control unit 150 may set a predetermined time limit (for example, 10 seconds), and if no user input is received within such time period after the notification is displayed, the notification (particularly, the notification by voice) may be performed again. Furthermore, if no user input is received within such time period after the notification is displayed, the control unit may continue to display the notification or may terminate the display of the notification by not performing (or performing) merging assistance. If user input is not made despite the notification, it is possible to give an opportunity to recognize the notification to the user who is not aware of the start of the notification by making the notification again or continuing the notification. Note that, if there are a plurality of junctions within the reference range, the control unit 150 may provide individual notifications of each of the junctions, or may issue a single notification of confirmation as to whether or not to execute merging assistance processing for all of the junctions.

Furthermore, for example, the control unit 150 may display the notification and, if no user input is received when the vehicle M enters an acceleration section, which will be described later, may notify the user again. This processing allows a reduction in the possibility that the user remains unaware of the notification before entering the merging point.

Note that the description here is based on the assumption that if a junction is identified, notification regarding merging at the junction is controlled, but other conditions may be provided as long as notification regarding merging at the identified junction is controlled. For example, the route along which the vehicle M is scheduled to travel in the map information may be acquired, and control of notification regarding merging may be performed only for the junctions identified on that route.

Furthermore, for example, the control unit 150 may estimate a merging point in the junction and provide notification at a timing based on the estimated merging point. For example, the control unit 150 may provide notification at the timing when the vehicle M reaches a predetermined distance (for example, 3 km) from the estimated merging point, or may provide notification at a point where the expected time of arrival at the estimated merging point becomes a predetermined time (for example, 5 minutes). Here, it is assumed that the point of the node in the map information at the junction is used as a merging point, but the merging point may be estimated by different processing, such as estimating the merging point by further using the surrounding situation of the vehicle. This processing allows notification to be executed at the appropriate timing based on the estimated merging point.

Further, for example, if it is determined by the determination unit 140 to be described later that the vehicle M is traveling in the merging section, notification regarding merging at the junction corresponding to the merging section may be controlled. Furthermore, if it is determined by the determination unit 140 that the vehicle M is traveling in a merging assistance section to be described later, notification regarding merging at the junction corresponding to the merging section may be controlled, and this processing will be described later. In this manner, the determination unit 140 determines whether or not the identified junction is subject to notification control, and the control unit 150 can provide notification regarding merging for the junction determined to be subject to notification control.

The recognition unit 130 recognizes the state, such as the position, speed, and acceleration, of an object around the vehicle M on the basis of information input from the camera 10, the radar device 12, and the LiDAR 14 via the object recognition device 16. The position of the object is recognized as, for example, a position in absolute coordinates with the representative point of the vehicle M (center of gravity, drive shaft center, or the like) as the origin, and is used for control. The position of the object may be represented by a representative point, such as the center of gravity or a corner of the object, or by a represented region. The “state” of the object may include the acceleration, jerk, or the like of the object.

Furthermore, the recognition unit 130 recognizes, for example, a lane (travel lane) on which the vehicle Mis traveling. For example, the recognition unit 130 recognizes the travel lane by comparing the pattern of lane markings (for example, an array of solid lines and dashed lines) acquired from the map information of the navigation device 50 with the pattern of lane markings around the vehicle M recognized from the image captured by the camera 10. Note that the recognition unit 130 may recognize the travel lane by recognizing not only the lane markings but also road boundaries including lane markings, road shoulders, curbs, median strips, guardrails, and the like. In this recognition, the position of the vehicle M acquired from the navigation device 50 and the results of processing by the INS may be taken into consideration.

On the basis of the surrounding situation of the vehicle M recognized by the recognition unit 130, the determination unit 140 can determine whether or not the situation requires a notification to confirm whether or not to execute merging assistance processing. Here, for example, the determination unit 140 can determine whether or not the vehicle M is in the merging assistance section where merging assistance is executed, on the basis of the surrounding situation of the vehicle M. The merging assistance section according to the present embodiment includes a preparation section, an acceleration section, and a merging section.

The determination unit 140 according to the present embodiment can first estimate a merging point in the junction where merging is to be performed, and determine whether or not the vehicle M is traveling in the merging assistance section on the basis of the estimated merging point and the current position of the vehicle M. Here, the determination unit 140 may determine that the vehicle Mis traveling in the merging assistance section if the vehicle M is within a predetermined distance (for example, 3 km) from the estimated merging point, or may determine that the vehicle M is traveling in the merging assistance section if the expected time of arrival at the estimated merging point is within a predetermined time (for example, 5 minutes). Next, if it is determined that the vehicle Mis traveling in the merging assistance section, the vehicle M determines, on the basis of the surrounding situation of the vehicle M, whether the vehicle M is traveling in the acceleration section of the merging lane, traveling in the merging section, or neither when the vehicle M changes lanes from the merging lane to the merged lane. Here, the acceleration section refers to a section for the occupant of the vehicle M to perform a run-up (that is, depress the accelerator) in preparation for changing lanes from the merging lane to the merged lane, and the merging section refers to a section for actually changing lanes from the merging lane to the merged lane after the run-up. In addition, if it is determined that the vehicle M is traveling in the merging assistance section and is neither traveling in the acceleration section nor in the merging section, it is determined that the vehicle Mis traveling in the preparation section.

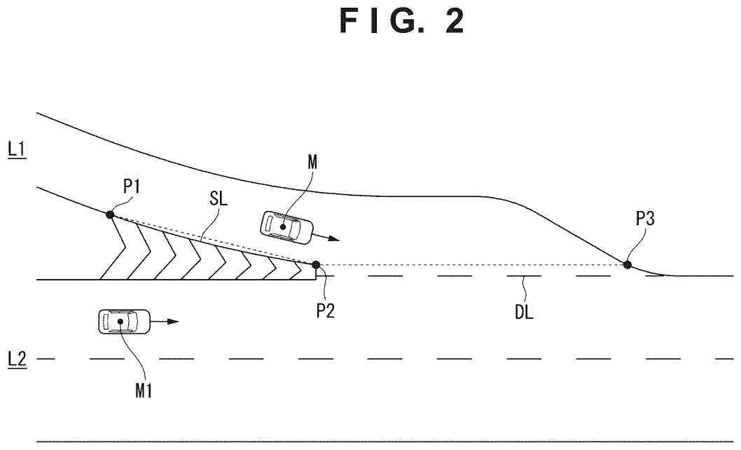

FIG. 2 illustrates determination processing performed by the determination unit 140. FIG. 2 illustrates, as an example, a scene in which the vehicle M merges from a merging lane L1 to a merged lane L2. As described above, the scene in which the vehicle M merges from the merging lane L1 into the merged lane L2 is recognized, for example, by the recognition unit 130 checking the position of the vehicle M measured by the navigation device 50 against the map information.

If at least one of a zebra zone (guiding zone) and a separation pole is recognized by the recognition unit 130, the determination unit 140 determines the first point where at least one of the zebra zone and the separation pole exists as the start point of the acceleration section (that is, the end point of the preparation section), and determines the last point where at least one of the zebra zone and the separation pole exists as the end point of the acceleration section. Therefore, the section from entry into the merging assistance section to point P1 is determined as the preparation section. If the vehicle Mis present between the start point and the end point, the determination unit 140 determines that the vehicle M is traveling in the acceleration section. In the case of FIG. 2, the determination unit 140 determines the section between the point P1, which is the first point where the zebra zone exists, and point P2, which is the last point where the zebra zone exists, as the acceleration section.

If it is recognized by the recognition unit 130 that the vehicle M has passed through the end point of the acceleration section, the determination unit 140 determines that the vehicle Mis traveling in the merging section. Furthermore, for example, if a point where the lane markings of the merging lane recognized by the recognition unit 130 change from solid lines to dashed lines is recognized, the determination unit 140 may determine that point as the start point of the merging section and, when the vehicle M passes through the start point, determine that the vehicle M is traveling in the merging section. In the case of FIG. 2, using either method, the determination unit 140 determines that the vehicle Mis traveling in the merging section when the vehicle M passes through the point P2.

The control unit 150 performs merging assistance processing with different notification contents depending on whether the vehicle M is determined to be traveling in the acceleration section or in the merging section. Here, if the vehicle M is determined to be traveling in the acceleration section, the control unit 150 can cause the HMI 30 to execute merging assistance using images and sound. FIG. 4 illustrates an example of merging assistance executed by the control unit 150 when the vehicle M travels in the acceleration section. As illustrated in FIG. 4, for example, upon determining that the risk to the vehicle Mis low on the basis of the surrounding situation recognized by the recognition unit 130, the control unit 150 causes the HMI 30 to display an image IM1 that strongly encourages accelerator operation, together with the output of the electronic sound. Here, the risk is, for example, a time to collision (TTC) in the travel direction of another vehicle Ml with respect to the vehicle M, and the control unit 150 determines that the risk to the vehicle M is low, for example, if the TTC is equal to or greater than a first threshold value. If the vehicle M is traveling in the acceleration section, the occupant of the vehicle M generally tends to have plenty of room to check the screen of the HMI 30. Therefore, the control unit 150 causes the HMI 30 to execute driving assistance using both images and sound.

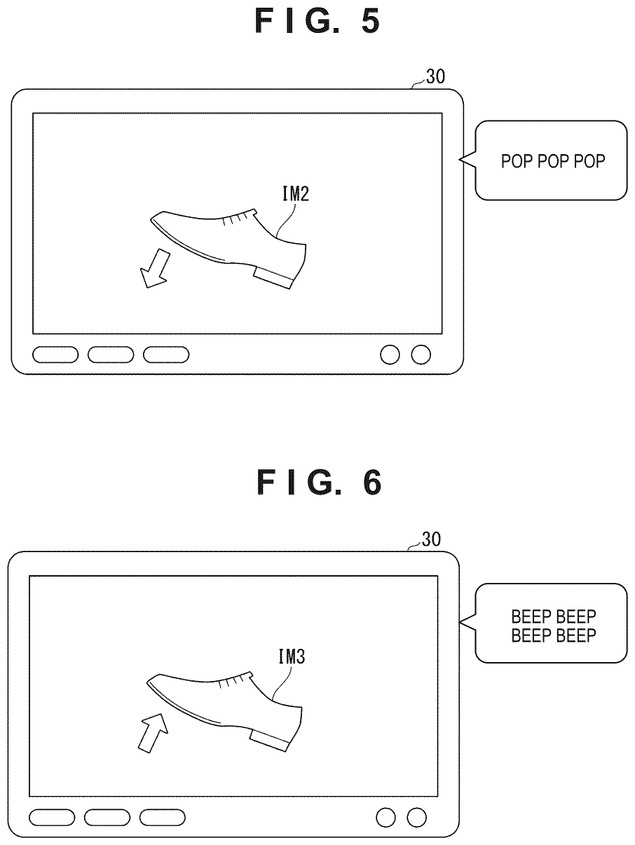

FIG. 5 illustrates another example of merging assistance executed by the control unit 150 when the vehicle M travels in the acceleration section. As illustrated in FIG. 5, for example, upon determining that the risk to the vehicle M is medium on the basis of the surrounding situation recognized by the recognition unit 130, the control unit 150 causes the HMI 30 to display an image IM2 that lightly encourages the occupant to operate the accelerator, together with the output of the electronic sound. For example, if the TTC is less than the first threshold value and equal to or greater than a second threshold value, the control unit 150 determines that the risk to the vehicle M is medium.

Note that the approach to accelerator operation recommendations based on the value of the TTC may be reversed between the case of FIG. 4 and the case of FIG. 5. More specifically, if the TTC is equal to or greater than the first threshold value, the control unit 150 may cause the HMI 30 to display the image IM2, which lightly encourages accelerator operation, together with the output of the electronic sound, and if the TTC is less than the first threshold value and equal to or greater than the second threshold value, the control unit 150 may cause the HMI 30 to display the image IM1, which strongly encourages the occupant to operate the accelerator, together with the output of the electronic sound.

FIG. 6 illustrates still another example of merging assistance executed by the control unit 150 when the vehicle M travels in the acceleration section. As illustrated in FIG. 6, for example, upon determining that the risk to the vehicle M is high on the basis of the surrounding situation recognized by the recognition unit 130, the control unit 150 causes the HMI 30 to display an image IM3 indicating that accelerator operation is not recommended, together with the output of the electronic sound. For example, if the TTC is less than the second threshold value, the control unit 150 determines that the risk to the vehicle M is high.

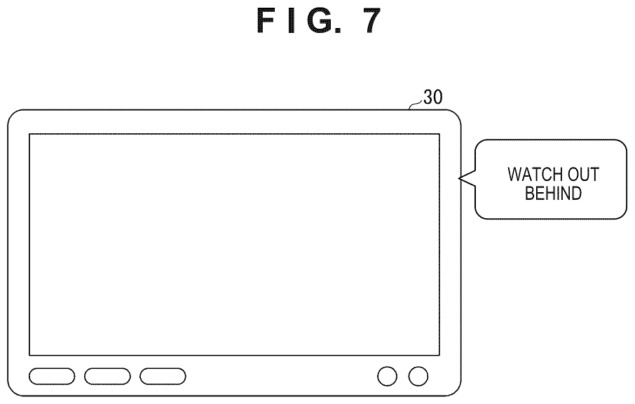

If it is determined that the vehicle M is traveling in the merging section, the control unit 150 can cause the HMI 30 to execute merging assistance using sound and not to execute merging assistance using images. FIG. 7 illustrates an example of merging assistance executed by the control unit 150 when the vehicle M travels in the merging section. As illustrated in FIG. 7, for example, upon determining that the risk to the vehicle Mis low on the basis of the surrounding situation recognized by the recognition unit 130, the control unit 150 causes the HMI 30 to output a sound in natural language such as “Watch out behind”. Meanwhile, upon determining that the risk to the vehicle M is high, the control unit 150 causes the HMI 30 to output a sound in natural language such as “Danger on the right”, “Danger on the left”, or “Danger behind”. If the vehicle Mis traveling in the merging section, the occupant of the vehicle M generally tends to have little room to check the screen of the HMI 30. Therefore, the control unit 150 causes the HMI 30 to execute driving assistance using sound. In the present embodiment, notification by voice promoting the user to monitor the surroundings, such as “Watch out behind” or “Danger on the right” (“direction prompting monitoring”+ “content of notification to user”), may be provided in the merging section.

As described above, if the vehicle M is traveling in the acceleration section and the occupant is assumed to have plenty of room to check the screen of the HMI 30, the control unit 150 places emphasis on acceleration assistance and causes the HMI 30 to execute driving assistance using both images and sound. Meanwhile, if the vehicle M is traveling in the merging section and the occupant is assumed to have little room to check the screen of the HMI 30, the control unit 150 places emphasis on alerting the occupant to the risk behind and causes the HMI 30 to execute driving assistance using sound and not to execute merging assistance using images. As a result, it is possible to reduce the sense of incongruity felt by the occupant with respect to the mode of driving assistance when changing lanes.

Note that in the above description, if it is determined by the determination unit 140 that the vehicle Mis traveling in the acceleration section, the control unit 150 causes the HMI 30 to execute driving assistance using both images and sound. In order to allow the occupant of the vehicle M to perform a run-up with plenty of margin, if the start point (point P1 in FIG. 2) of the acceleration section is recognized by the recognition unit 130, the control unit 150 may cause the HMI 30 to provide notification of the start of merging assistance a predetermined time before the vehicle M enters the acceleration section (that is, a predetermined time before the merging assistance is executed). Furthermore, if it is determined by the determination unit 140 that the vehicle M is traveling in the acceleration section, the control unit 150 may cause the HMI 30 to output instruction information regarding the accelerator operation by sound to cause the occupant to recognize the start of merging assistance, and then output the instruction information by an image. As a result, it is possible to further reduce the sense of incongruity felt by the occupant with respect to the mode of driving assistance when changing lanes.

In particular, the control unit 150 may provide notification when the vehicle M enters the preparation section. Furthermore, for example, the control unit 150 may provide notification if it is determined that the vehicle M has entered the preparation section and is traveling on the junction. By setting a plurality of determination criteria for notification in this manner, the possibility of erroneous notification can be reduced.

Furthermore, the control unit 150 may acquire an execution history including the number of times the user has used the merging assistance processing, and determine whether or not to provide notification of whether or not to execute the merging assistance processing on the basis of the execution history. For example, the control unit 150 may provide notification of whether or not to execute the merging assistance processing if the number of times the user has used the merging assistance processing for a predetermined period (for example, two months) is equal to or more than a predetermined threshold value. For this purpose, the driving assistance apparatus 100 may include a storage unit (not illustrated) and store a database that records, for each date, the execution history of the merging assistance processing by the user. This processing can be expected to reduce unnecessary notifications to the user whose number of times of use of the merging assistance processing has decreased.

Note that, referring only to the number of times of use of the merging assistance processing during a predetermined period, it may be impossible to determine whether the frequency of execution of the merging assistance processing has decreased or the frequency of use of the vehicle itself has decreased. From such a viewpoint, for example, the control unit 150 may acquire the driving history of the vehicle M by the user in addition to the number of times the user has used the merging assistance processing, and provide notification of whether or not to execute the merging assistance processing if the ratio of use of the merging assistance processing in the driving of the user is a predetermined threshold value (for example, 30%) or more. For this purpose, the driving assistance apparatus 100 may use a storage unit (not illustrated) to store a database that records the driving history of the vehicle M by the user for each date. This processing can be expected to reduce unnecessary notifications to the user whose frequency of use of the merging assistance processing has decreased.

In addition, when performing the merging assistance processing, the user's familiarity or unfamiliarity with the shape of the junction may arise, and the degree of use of the merging assistance processing may also vary depending on such shape. From such a viewpoint, the control unit 150 may classify the junctions where the user has performed the merging assistance processing according to the shape, and for each classification of the junctions, provide notification of whether or not to execute the merging assistance processing if the ratio of use of the merging assistance processing in the driving of the user is a predetermined threshold value (for example, 30%) or more. For example, the shapes of the junctions may be classified according to the angle at which two roads join at the junction (for example, three classifications: 0-30 degrees/30-70 degrees/70-90 degrees), or according to whether or not the junctions have a characteristic shape, and the classification is not limited as long as the junctions can be classified according to their shape. This processing can avoid unnecessary notifications to the user at types of junctions that have decreased in frequency of use.

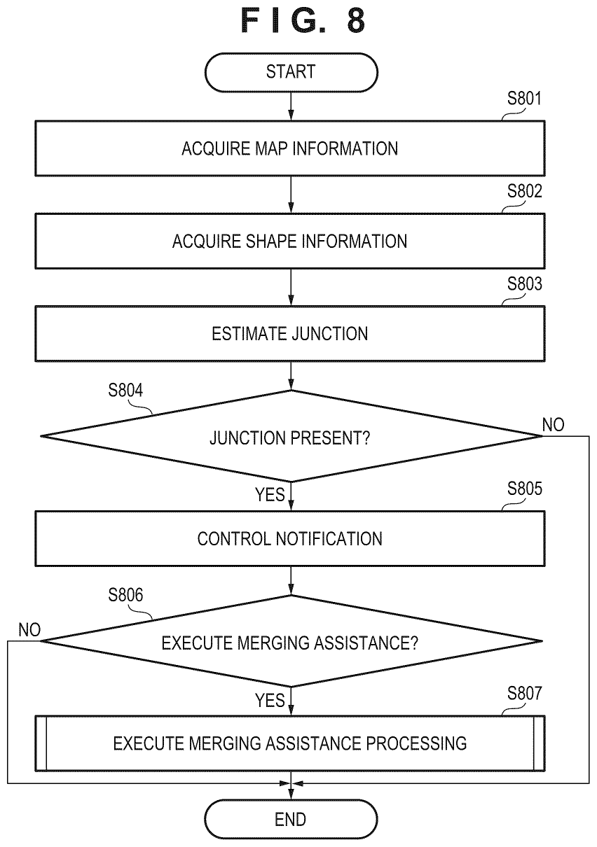

Next, a flow of processing executed by the driving assistance apparatus 100 according to the present embodiment will be described with reference to FIG. 8. FIG. 8 is a flowchart illustrating an example of driving assistance processing executed by the driving assistance apparatus 100. The processing illustrated in FIG. 8 is started, for example, at the startup of the vehicle M or the driving assistance apparatus 100, and is repeatedly executed in a predetermined cycle while the vehicle Mis traveling.

In step S801, the acquisition unit 110 acquires map information. In the present embodiment, the acquisition unit 110 acquires map information from the navigation device 50. In step S802, the acquisition unit 110 acquires shape information of a road within a predetermined range on the basis of the acquired map information. Here, information of links and nodes in a range of 5 km×5 km with the vehicle M as the center in the map information is acquired as road shape information.

In step S803, the identification unit 120 identifies a junction on the road within the reference range on the basis of the shape information acquired in step S802. In step S804, on the basis of the result of the identification of the junction in step S803, the determination unit 140 determines the presence or absence of a junction that is subject to notification control. If such junction exists, the processing proceeds to step S805, otherwise, the processing ends. Here, it is assumed that all junctions in the road within the reference range are determined to be junctions that are subject to notification control.

In step S805, the control unit 150 controls notification regarding merging, for the junction determined to be subject to notification control in step S804. Here, the control unit 150 causes the HMI 30 to display a confirmation as to whether or not to execute the merging assistance processing at the junction. In step S806, the control unit 150 determines whether or not to execute the merging assistance processing. If the merging assistance processing is to be executed, the processing proceeds to step S807, and otherwise, the processing ends. Here, it is assumed that the control unit 150 accepts user input, and executes the merging assistance processing if the input for executing the merging assistance processing is made.

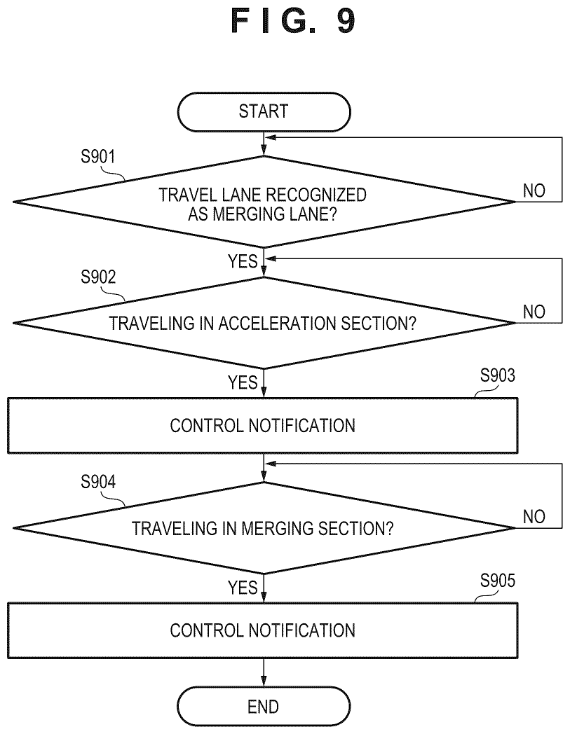

In step S807, the control unit 150 executes the merging assistance processing and ends the processing in FIG. 8. The merging assistance processing will be described later with reference to FIG. 9.

FIG. 9 is a flowchart illustrating an example of the flow of the merging assistance processing executed in step S807 by the driving assistance apparatus 100.

In step S901, the recognition unit 130 checks the position of the vehicle M measured by the navigation device 50 against the map information to determine whether or not the travel lane is recognized as a merging lane. If the travel lane is not recognized as a merging lane, the recognition unit 130 executes the processing of step S901 again after a predetermined time. If the travel lane is recognized as a merging lane, the processing proceeds to step S902.

In step S902, the determination unit 140 determines whether or not the vehicle Mis traveling in the acceleration section, on the basis of the surrounding situation recognized by the recognition unit 130. If it is not determined that the vehicle Mis traveling in the acceleration section, the determination unit 140 executes the processing of step S902 again after a predetermined time. If it is determined that the vehicle Mis traveling in the acceleration section, the processing proceeds to step S903.

In step S903, the control unit 150 causes the HMI 30 to output instruction information related to the accelerator operation using both images and sound. In step S904, the determination unit 140 determines whether or not the vehicle Mis traveling in the merging section, on the basis of the surrounding situation recognized by the recognition unit 130. If it is not determined that the vehicle M is traveling in the merging section, the determination unit 140 executes the processing of step S904 again after a predetermined time. If it is determined that the vehicle M is traveling in the merging section, the processing proceeds to step S905.

In step S905, the control unit 150 causes the HMI 30 to output instruction information related to the accelerator operation only by sound, and ends the processing.

With this configuration, it is possible to acquire shape information of a road within a predetermined range on the basis of the acquired map information and to identify a junction on the basis of the shape information. Next, if a junction is identified on the road within the predetermined range, notification regarding merging at the junction can be controlled for the vehicle M. Therefore, it is possible to determine whether or not a place is a junction on the basis of road shape information. In addition, by identifying a junction from a road within a predetermined range, it is expected to reduce the processing load.

### Summary of Embodiment

The above embodiment discloses at least the following driving assistance apparatus, information processing method, and program.

1. A driving assistance apparatus according to the above embodiment (for example, 100) comprises:
a first acquisition unit configured to acquire map information;
a second acquisition unit configured to acquire shape information of a road within a predetermined range with respect to a mobile unit on a basis of the map information;
an identification unit configured to identify a junction on the road within the predetermined range on the basis of the shape information; and
a first control unit configured to control notification regarding to merging at the identified junction, for the mobile unit in a case where a junction is identified in the road within the predetermined range.

According to this embodiment, it is possible to identify a junction on the basis of road shape information and reduce the processing load.

2. In the driving assistance apparatus according to the above embodiment, the predetermined range is a region that is determined on the basis of a position of the mobile unit.

According to this embodiment, it is possible to dynamically identify a junction according to the movement of the mobile unit.

3. In the driving assistance apparatus according to the above embodiment, wherein the predetermined range is a region that is further determined on the basis of a speed of the mobile unit.

According to this embodiment, it is possible to identify a junction from a suitable range according to the speed of the mobile unit.

4. In the driving assistance apparatus according to the above embodiment, wherein the predetermined range is a rectangular range with the mobile unit as a center.

According to this embodiment, it is possible to identify a junction from a rectangular range.

5. The driving assistance apparatus according to the above embodiment, further comprises a first setting unit configured to set a candidate for a junction in the map information, wherein the second acquisition unit acquires a shape of a road within a predetermined range including the candidate for the junction, as the shape of the road within the predetermined range.

According to this embodiment, it is possible to set up a candidate first and then identify a junction from such range as to include the candidate.

6. In the driving assistance apparatus according to the above embodiment, wherein the identification unit further identifies the number of roads and the number of intersections within the predetermined range, and
the driving assistance apparatus further comprising
a change unit configured to change the predetermined range on the basis of the number of roads and the number of intersections within the predetermined range as identified by the identification unit.

According to this embodiment, it is possible to reduce the possibility of erroneous estimation in a region where roads are congested.

7. In the driving assistance apparatus according to the above embodiment, wherein in a case where a sum of the number of roads and the number of intersections identified by the identification unit is equal to or greater than a predetermined threshold value, the change unit changes the predetermined range to be smaller.

According to this embodiment, in a region where roads are congested, it is possible to improve the accuracy of identification by identifying a junction from a smaller range.

8. In the driving assistance apparatus according to the above embodiment, wherein the number of roads is the number of links indicating the roads in the map information, and the number of intersections is the number of nodes connected by the links.

According to this embodiment, it is possible to determine a reference range from the links and nodes contained in map information.

9. In the driving assistance apparatus according to the above embodiment, further comprising
a second setting unit configured to set a plurality of conditions for identifying the junction, the plurality of conditions being related to the shape information, wherein
the identification unit identifies, as the junction, a place that satisfies the conditions set by the second setting unit.

According to this embodiment, it is possible to set appropriate conditions for identifying a junction.

10. In the driving assistance apparatus according to the above embodiment, wherein the identification unit identifies, as the junction, a place that satisfies at least two of the conditions set by the second setting unit.

According to this embodiment, identifying a junction on the basis of a plurality of determination conditions allows a reduction in the possibility of incorrect notification regarding the junction.

11. In the driving assistance apparatus according to the above embodiment, wherein each of the conditions related to the shape information is any of the following: the number of lanes on a road after the road joins another road is two or more; the number of lanes on a road before the road joins another road is two or less; an angle at which two roads join is a predetermined threshold value or less; and a road before or after the joining has an attribute added to the road in the map information, the attribute being a predetermined attribute.

According to this embodiment, it is possible to set an appropriate condition for identifying a junction.

12. In the driving assistance apparatus according to the above embodiment, wherein the conditions related to the shape information include a condition based on links indicating the roads in the map information and nodes connected by the links.

According to this embodiment, it is possible to identify a junction from information contained in map information.

13. In the driving assistance apparatus according to the above embodiment, wherein the first control unit controls the notification in a case where it is determined that the mobile unit is traveling at the junction.

According to this embodiment, it is possible to start notification when traveling at the junction.

14. In the driving assistance apparatus according to the above embodiment, further comprising
an estimation unit configured to estimate a merging point in the identified junction, wherein
the first control unit controls the notification at a timing based on the estimated merging point.

According to this embodiment, it is possible to start notification at a timing suitable for the merging point.

15. In the driving assistance apparatus according to the above embodiment, wherein the first control unit controls the notification at a predetermined distance from the merging point or at a point at which an expected time of arrival at the merging point becomes a predetermined time.

According to this embodiment, it is possible to start notification at an appropriate timing.

16. The driving assistance apparatus according to claim 1, further comprises:
a recognition unit configured to recognize a surrounding situation of the mobile unit; and
a first determination unit configured to determine whether or not the recognized surrounding situation of the mobile unit is a situation for the notification by the first control unit, wherein
in a case where it is determined by the first determination unit that the notification is to be provided, the first control unit provides the notification.

According to this embodiment, it is possible to determine as to whether or not to provide notification by also considering the surrounding situation of the mobile unit.

17. In the driving assistance apparatus according to the above embodiment, wherein in a case where it is determined by the first determination unit that the notification is to be provided and that the mobile unit is traveling at the junction, the first control unit provides the notification.

According to this embodiment, it is possible to reduce the possibility of erroneous notification by setting the plurality of conditions.

18. In the driving assistance apparatus according to the above embodiment, wherein in a case where a junction is identified in the road within the predetermined range, the first control unit provides notification of whether or not to execute merging assistance processing when merging at the junction.

According to this embodiment, if a junction can be identified, notification can be provided.

19. In the driving assistance apparatus according to the above embodiment, wherein in a case where no user input is received for a predetermined period of time in response to the notification of whether or not to execute the merging assistance processing, the first control unit continues or provides again the notification of whether or not to execute the merging assistance processing. According to this embodiment, it is possible to give a user who is not aware of the start of a notification an opportunity to recognize the notification.

20. The driving assistance apparatus according to the above embodiment, further comprises:
a recognition unit configured to recognize a surrounding situation of the mobile unit;
a second determination unit configured to determine, on the basis of the recognized surrounding situation, whether the mobile unit is traveling in an acceleration section or a merging section of the merging lane when the mobile unit changes lanes from a merging lane to a merged lane; and
a second control unit configured to control a notification device to make different notifications as the merging assistance processing when the mobile unit is determined to be traveling in the acceleration section and when the mobile unit is determined to be traveling in the merging section, the notification device being mounted on the mobile unit, wherein
in a case where no user input is received in response to the notification of whether or not to execute the merging assistance processing when the mobile unit enters the acceleration section, the first control unit again provides the notification of whether or not to execute the merging assistance processing.

According to this embodiment, it is possible to give a user who is not aware of the start of a notification an opportunity to recognize the notification.

21. The driving assistance apparatus according to claim 18, further comprising
a third acquisition unit configured to acquire the number of times a user of the mobile unit has used the merging assistance processing, wherein
in a case where the number of times of use is less than a predetermined threshold value, the first control unit provides the notification of whether or not to execute the merging assistance processing.

According to this embodiment, it is possible to reduce unnecessary notifications to the user whose number of times of use of the merging assistance processing has decreased.

22. The driving assistance apparatus according to the above embodiment, further comprises
a fourth acquisition unit configured to acquire the number of times a user of the mobile unit has used the merging assistance processing and a driving history of the mobile unit by the user, wherein
in a case where a ratio of use of the merging assistance processing during driving of the mobile unit by the user is less than a predetermined threshold value, the first control unit provides the notification of whether or not to execute the merging assistance processing.

According to this embodiment, it is possible to reduce unnecessary notifications to the user whose frequency of use of the merging assistance processing has decreased.

23. The driving assistance apparatus according to the above embodiment, further comprises
a classification unit configured to classify shapes of junctions, wherein
in a case where a ratio of use of the merging assistance processing for each classification of the junctions during driving of the mobile unit by a user is less than a predetermined threshold value, the notification of whether or not to execute the merging assistance processing is provided.

According to this embodiment, it is possible to reduce unnecessary notifications to the user at the junctions with shapes where the frequency of use of the merging assistance has decreased.

24. A driving assistance method according to the above embodiment comprises:
acquiring map information;
acquiring shape information of a road within a predetermined range with respect to a mobile unit on a basis of the map information;
identifying a junction on the road within the predetermined range on the basis of the shape information; and
controlling notification regarding to merging at the identified junction, for the mobile unit in a case where a junction is identified in the road within the predetermined range.

According to this embodiment, it is possible to identify a junction on the basis of road shape information and reduce the processing load.

25. A non-transitory computer-readable storage medium according to the above embodiment stores a program that, when executed by a computer, causes the computer to perform a driving assistance method comprising:
acquiring map information;
acquiring shape information of a road within a predetermined range with respect to a mobile unit on a basis of the map information;
identifying a junction on the road within the predetermined range on the basis of the shape information; and
controlling notification regarding to merging at the identified junction, for the mobile unit in a case where a junction is identified in the road within the predetermined range.

According to this embodiment, it is possible to identify a junction on the basis of road shape information and reduce the processing load.

Heretofore, the embodiment of the invention has been described.

The invention is not limited to the foregoing embodiments, and various variations/changes are possible within the spirit of the invention.

What is claimed is:

1. A driving assistance apparatus comprising:
a first acquisition unit configured to acquire map information;
a second acquisition unit configured to acquire shape information of a road within a predetermined range with respect to a mobile unit on a basis of the map information;
an identification unit configured to identify a junction on the road within the predetermined range on the basis of the shape information; and
a first control unit configured to control notification regarding to merging at the identified junction, for the mobile unit in a case where a junction is identified in the road within the predetermined range.

2. The driving assistance apparatus according to claim 1, wherein the predetermined range is a region that is determined on the basis of a position of the mobile unit.

3. The driving assistance apparatus according to claim 2, wherein the predetermined range is a region that is further determined on the basis of a speed of the mobile unit.

4. The driving assistance apparatus according to claim 2, wherein the predetermined range is a rectangular range with the mobile unit as a center.

5. The driving assistance apparatus according to claim 2, further comprising a first setting unit configured to set a candidate for a junction in the map information, wherein
the second acquisition unit acquires a shape of a road within a predetermined range including the candidate for the junction, as the shape of the road within the predetermined range.

6. The driving assistance apparatus according to claim 1, wherein the identification unit further identifies the number of roads and the number of intersections within the predetermined range, and
the driving assistance apparatus further comprising
a change unit configured to change the predetermined range on the basis of the number of roads and the number of intersections within the predetermined range as identified by the identification unit.

7. The driving assistance apparatus according to claim 6, wherein in a case where a sum of the number of roads and the number of intersections identified by the identification unit is equal to or greater than a predetermined threshold value, the change unit changes the predetermined range to be smaller.

8. The driving assistance apparatus according to claim 6, wherein the number of roads is the number of links indicating the roads in the map information, and the number of intersections is the number of nodes connected by the links.

9. The driving assistance apparatus according to claim 1, further comprising
a second setting unit configured to set a plurality of conditions for identifying the junction, the plurality of conditions being related to the shape information, wherein
the identification unit identifies, as the junction, a place that satisfies the conditions set by the second setting unit.

10. The driving assistance apparatus according to claim 9, wherein the identification unit identifies, as the junction, a place that satisfies at least two of the conditions set by the second setting unit.

11. The driving assistance apparatus according to claim 9, wherein each of the conditions related to the shape information is any of the following: the number of lanes on a road after the road joins another road is two or more; the number of lanes on a road before the road joins another road is two or less; an angle at which two roads join is a predetermined threshold value or less; and a road before or after the joining has an attribute added to the road in the map information, the attribute being a predetermined attribute.

12. The driving assistance apparatus according to claim 9, wherein the conditions related to the shape information include a condition based on links indicating the roads in the map information and nodes connected by the links.

13. The driving assistance apparatus according to claim 1, wherein the first control unit controls the notification in a case where it is determined that the mobile unit is traveling at the junction.

14. The driving assistance apparatus according to claim 1, further comprising
an estimation unit configured to estimate a merging point in the identified junction, wherein
the first control unit controls the notification at a timing based on the estimated merging point.

15. The driving assistance apparatus according to claim 14, wherein the first control unit controls the notification at a predetermined distance from the merging point or at a point at which an expected time of arrival at the merging point becomes a predetermined time.

16. The driving assistance apparatus according to claim 1, further comprising:
a recognition unit configured to recognize a surrounding situation of the mobile unit; and
a first determination unit configured to determine whether or not the recognized surrounding situation of the mobile unit is a situation for the notification by the first control unit, wherein
in a case where it is determined by the first determination unit that the notification is to be provided, the first control unit provides the notification.

17. The driving assistance apparatus according to claim 16, wherein in a case where it is determined by the first determination unit that the notification is to be provided and that the mobile unit is traveling at the junction, the first control unit provides the notification.

18. The driving assistance apparatus according to claim 1, wherein in a case where a junction is identified in the road within the predetermined range, the first control unit provides notification of whether or not to execute merging assistance processing when merging at the junction.

19. The driving assistance apparatus according to claim 18, wherein in a case where no user input is received for a predetermined period of time in response to the notification of whether or not to execute the merging assistance processing, the first control unit continues or provides again the notification of whether or not to execute the merging assistance processing.

20. The driving assistance apparatus according to claim 18, further comprising:
a recognition unit configured to recognize a surrounding situation of the mobile unit;
a second determination unit configured to determine, on the basis of the recognized surrounding situation, whether the mobile unit is traveling in an acceleration section or a merging section of the merging lane when the mobile unit changes lanes from a merging lane to a merged lane; and
a second control unit configured to control a notification device to make different notifications as the merging assistance processing when the mobile unit is determined to be traveling in the acceleration section and when the mobile unit is determined to be traveling in the merging section, the notification device being mounted on the mobile unit, wherein
in a case where no user input is received in response to the notification of whether or not to execute the merging assistance processing when the mobile unit enters the acceleration section, the first control unit again provides the notification of whether or not to execute the merging assistance processing.

21. The driving assistance apparatus according to claim 18, further comprising
a third acquisition unit configured to acquire the number of times a user of the mobile unit has used the merging assistance processing, wherein
in a case where the number of times of use is less than a predetermined threshold value, the first control unit provides the notification of whether or not to execute the merging assistance processing.

22. The driving assistance apparatus according to claim 18, further comprising
a fourth acquisition unit configured to acquire the number of times a user of the mobile unit has used the merging assistance processing and a driving history of the mobile unit by the user, wherein
in a case where a ratio of use of the merging assistance processing during driving of the mobile unit by the user is less than a predetermined threshold value, the first control unit provides the notification of whether or not to execute the merging assistance processing.

23. The driving assistance apparatus according to claim 19, further comprising
a classification unit configured to classify shapes of junctions, wherein
in a case where a ratio of use of the merging assistance processing for each classification of the junctions during driving of the mobile unit by a user is less than a predetermined threshold value, the notification of whether or not to execute the merging assistance processing is provided.

24. A driving assistance method comprising:
acquiring map information;
acquiring shape information of a road within a predetermined range with respect to a mobile unit on a basis of the map information;
identifying a junction on the road within the predetermined range on the basis of the shape information; and
controlling notification regarding to merging at the identified junction, for the mobile unit in a case where a junction is identified in the road within the predetermined range.

25. A non-transitory computer-readable storage medium storing a program that, when executed by a computer, causes the computer to perform a driving assistance method comprising:
acquiring map information;
acquiring shape information of a road within a predetermined range with respect to a mobile unit on a basis of the map information;
identifying a junction on the road within the predetermined range on the basis of the shape information; and
controlling notification regarding to merging at the identified junction, for the mobile unit in a case where a junction is identified in the road within the predetermined range.
